(19) United States
(12) Patent Application Publication
(10) Pub. No.: US 2006/0214497 A1
(43) Pub. Date: Sep. 28, 2006

(54) Structure of multiple wheel bodies integrated with an axial base

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/088,735

(22) Filed: Mar. 25, 2005

(51) Int. Cl. B60B 19/00

(52) U.S. Cl. 301/5.1

(57) ABSTRACT

A structure of multiple wheel bodies integrated with an axial base to increase contact area against the ground for securing firm and smooth operation includes at least two wheel bodies and an axial base. Each wheel body is provided to and made integrated with the axial base and shares the same outer diameter. An axial hole is provided to the axial base. The outer diameter of the axial base is smaller than that of the wheel body. The axial base may have a maximal outer diameter equal to that of the wheel body. Each wheel body wears a tire made of different material. The tire is either injection molded or casting molded, or directly mounted to the wheel body.

### BACKGROUND OF THE INVENTION

(a) Field of the Invention

The present invention relates to a structure of multiple wheel bodies integrated with an axial base, and more particularly to one adapted to fun or exercise equipment, e.g., retractable skate, bicycle, tricycle, skate board, skate, baby walker, suitcase, push cart, shopping cart, toy car, or balancing equipment, that achieves firm and smooth operation by increasing contact area against the ground.

(b) Description of the Prior Art

The structure of the retractable skate, tricycle and bicycle for children generally available in the market is vulnerable to tilt over when taking a turn due to the comparatively poor manipulation ability of the child. An improvement is made by having separately pivoted to both outer sides of the frame of the wheel a smaller track bearing an auxiliary wheel with the track then fixed to the frame. Both the auxiliary wheels and the wheel are not on the same axial base.

Addition of auxiliary wheel and its track means more manufacturing and assembly costs; increased members consume much more time in the assembly, and the track of the auxiliary wheel could easily get damaged due to collision. Therefore it is not very ideal in practical use.

### SUMMARY OF THE INVENTION

The primary purpose of the present invention is to provide a structure of multiple wheel bodies integrated with an axial base adapted to a fun or exercise equipment, e.g., retractable skate, bicycle, tricycle, skate board, skate, baby walker, suitcase, push cart, shopping cart, toy car, or balancing equipment, that achieves firm and smooth operation by increasing contact area against the ground. To achieve the purpose, the present invention includes at least two wheel bodies and an axial base; each wheel body being provided to and made integrated with the axial base and sharing the same outer diameter; and an axial hole being provided to the axial base. Wherein, the wheel bodies are made in the same outer diameter. Each wheel body wears a tire made of different material from that for the wheel body. The tire is either injection molded or casting molded, or directly mounted to the wheel body.

The present invention provides the following advantages:
1. Multiple wheel bodies in the same outer diameter are made integrated to the axial base to increase contact area against the ground to achieve firm and smooth operation.
2. Omitting the auxiliary wheels and track to save manufacturing and assembly time and costs, and preventing from being vulnerable to damage due to collision.
3. The wheel body can be blowing molded or injection molded; and the tire can be injection molded or casting molded, or directly mounted to the wheel body to provide easy manufacturing and assembly.

### BRIEF DESCRIPTION OF THE DRAWINGS

FIG. 1 is a perspective view of a first preferred embodiment of the present invention.

FIG. 2 is a front view of the first preferred embodiment of the present invention.

FIG. 3 is a front view of a second preferred embodiment of the present invention.

FIG. 4 is a front view of a third preferred embodiment of the present invention.

FIG. 5 is a front view of a fourth preferred embodiment of the present invention.

FIG. 6 is a front view of a fifth preferred embodiment of the present invention.

FIG. 7 is a front view of a sixth preferred embodiment of the present invention.

FIG. 8 is a rear view showing that the fifth preferred embodiment of the present invention is applied to a frame of a baby walker.

### DETAILED DESCRIPTION OF THE PREFERRED EMBODIMENTS

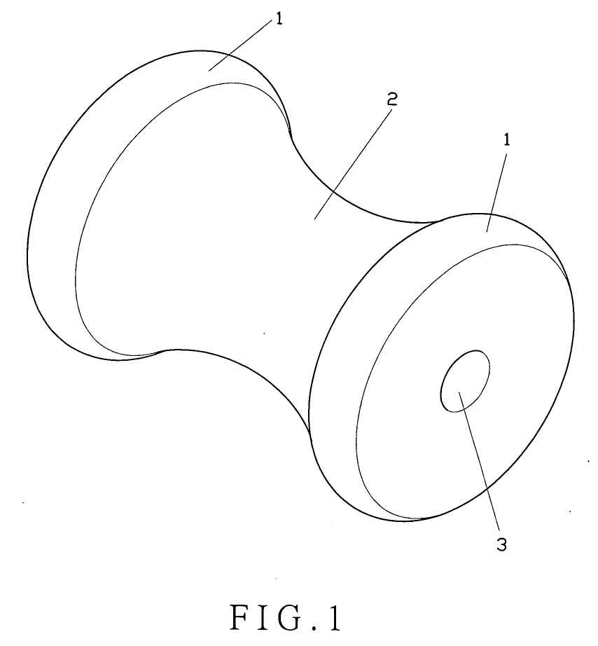

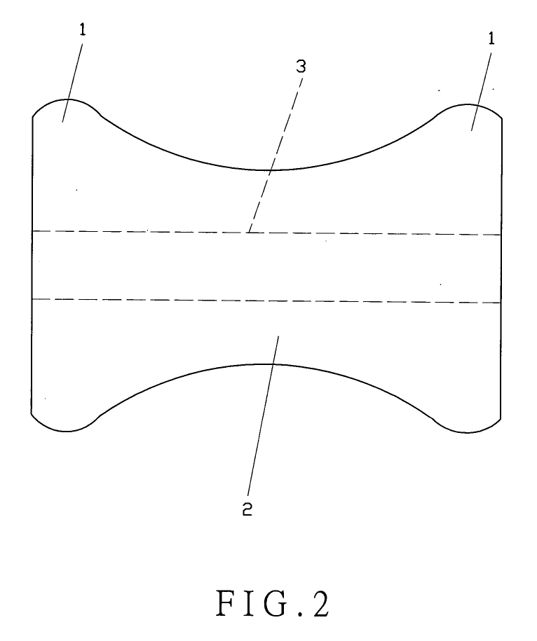

Referring to FIGS. 1 and 2, a first preferred embodiment of the present invention comprises two wheel bodies (1) and an axial base (2). The wheel bodies (1) are provided to and made integrated with the axial base (2). An axial hole (3) is provided to the axial base (2). The wheel bodies (1) share the same outer diameter, and the axial base (2) is made in recess at its central section and in a maximal outer diameter smaller than that of each wheel body (1). Accordingly the present invention achieves firm operation by increasing contact area with the ground.

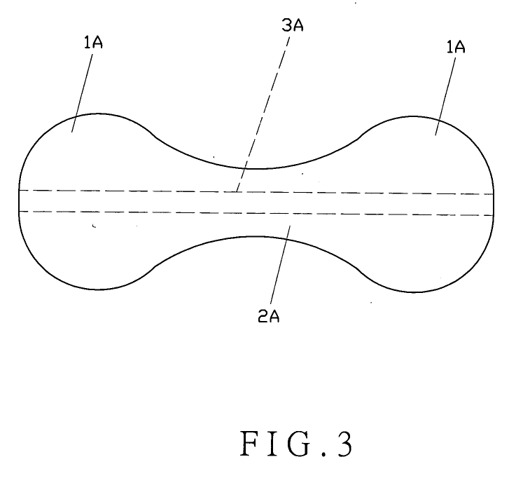

Now referring to FIG. 3, a second preferred embodiment of the present invention comprises two wheel bodies (1A) and an axial base (2A). The wheel bodies (1A) are provided to and made integrated with the axial base (2A). An axial hole (3A) is provided to the axial base (2A). The wheel bodies (1A) share the same outer diameter, and the axial base (2A) is made in recess at its central section and in a maximal outer diameter smaller than that of each wheel body (1A). The second preferred embodiment differs from the first preferred embodiment in that the geometric shape of the wheel body (1A) of the second preferred embodiment comparatively approximates that of a sphere.

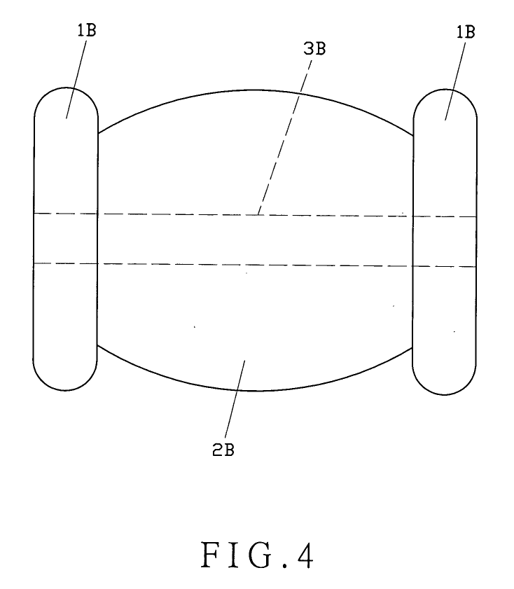

As illustrated in FIG. 4, a third preferred embodiment comprises two wheel bodies (1B) and an axial base (2B). The wheel bodies (1B) are provided to and made integrated with the axial base (2B). An axial hole (3B) is provided to the axial base (2B). The wheel bodies (1B) share the same outer diameter, and the axial base (2B) is made in protruding from its central section and in a maximal outer diameter same as that of each wheel body (1B). Compared to the first preferred embodiment, the axial base (2B) of the third preferred embodiment is in the form equivalent to that of the variation of the wheel body (1B) to actually provide a third wheel body (1B) to the third preferred embodiment of the present invention.

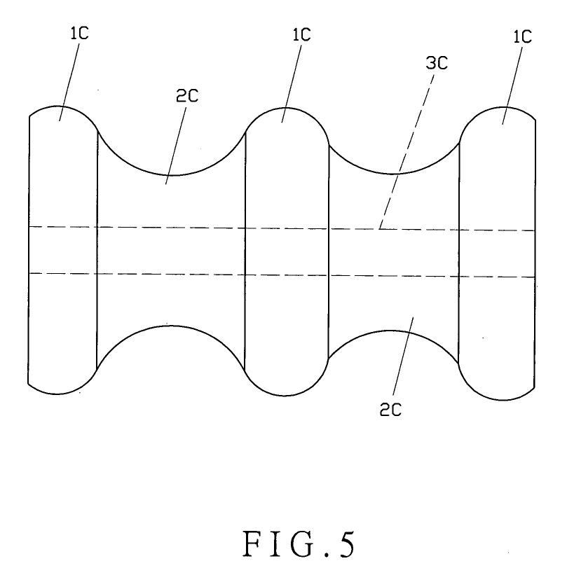

A fourth preferred embodiment of the present invention, as illustrated in FIG. 5, comprises three wheel bodies (1C) and an axial base (2C). The three wheel bodies (1C) sharing the same outer diameter are provided to and made integrated with the axial base (2C). An axial hole (3C) is provided to the axial base (2C). When compared to the first preferred embodiment, the fourth preferred embodiment is provided with an additional wheel body (1C).

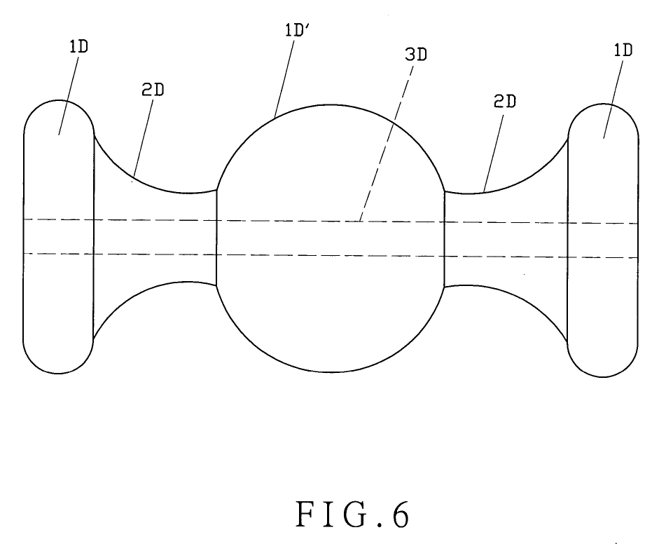

As illustrated in FIG. 6, a fifth preferred embodiment of the present invention comprises three wheel bodies (1D, 1D′) and an axial base (2D). An axial hole (3D) is provided to the axial base (2D). All the three wheel bodies (1D, 1D′) in the same outer diameter are provided to and made integrated with the axial base (2D). The central portion of the axial base (2D) is made in recess and the maximal outer diameter is smaller than that of each wheel body (1D or 1D′). The wheel body (1D′) of the fifth preferred embodiment, when compared to the fourth preferred embodiment, has its geometric form similar to that of a sphere and different from that of the wheel body (1D).

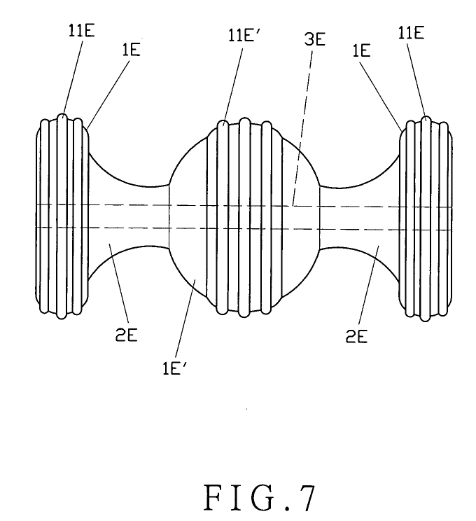

As illustrated in FIG. 7, a sixth preferred embodiment of the present invention, similar to the fifth preferred embodiment, comprises three wheel bodies (1E, 1E′) and an axial base (2E). An axial hole (3E) is provided to the axial base (2E). All the three wheel bodies (1E, 1E′) in the same outer diameter are provided to and made integrated with the axial base (2E). The central portion of the axial base (2E) is made in recess and the maximal outer diameter is smaller than that of each wheel body (1E or 1E′). The wheel body (1E′) has its geometric shape similar to that of a sphere and different from that of the wheel body (1E). Each of the wheel bodies (1E, 1E′) wears a tire (11E, 11E′) made of different material from that for the wheel bodies (11E, 11E′). The tire (11E, 11E′) is molded either by injection or casting, or is directly mounted to the wheel body.

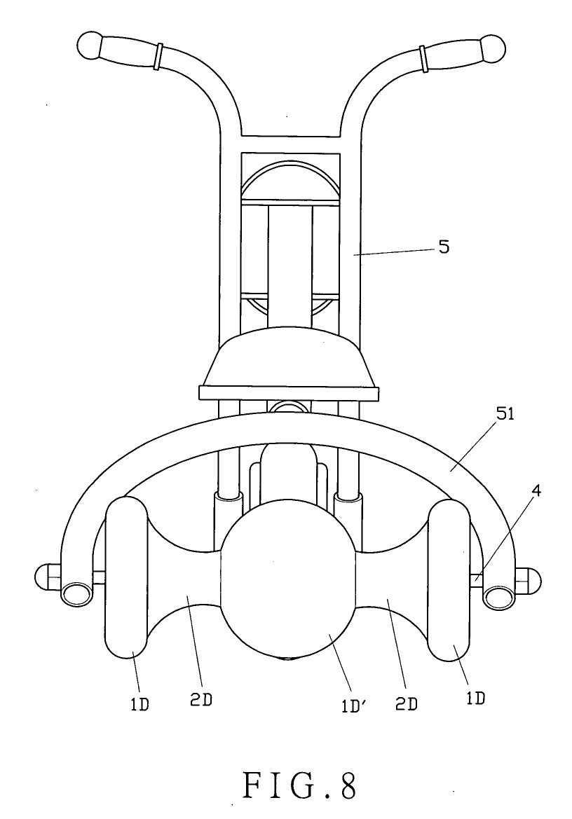

With the fifth preferred embodiment as an example, when the present invention is adapted to a frame of a baby walker as illustrated in FIG. 8, an axle (4) penetrating through the axial hole (3D) is used to pivot the wheel bodies (1D, 1D′) and the axial base (2D) to a wheel support (51) of a frame (5) to increase the contact area against the ground for the baby walker to achieve smooth operation.

Two or three wheel bodies are given in all the preferred embodiments described above. However, it is to be noted that the number of the wheel bodies is not restricted and the variation of the maximal outer diameter of the axial base is equal to that of the wheel body also falling within the scope of the teaching of the present invention.

What is claimed is:

1. A structure of multiple wheel bodies integrated with an axial base comprising at least two wheel bodies and an axial base; each wheel body being provided to and made integrated with the axial base and sharing the same outer diameter; and an axial hole being provided to the axial base.

2. The structure of multiple wheel bodies integrated with an axial base of claim 1, wherein the wheel bodies are arranged in equal spacing to the axial base, and the axial base has a maximal outer diameter smaller than that of each wheel body.

3. The structure of multiple wheel bodies integrated with an axial base of claim 1, wherein the wheel bodies are arranged in equal spacing to the axial base, and the axial base has a maximal outer diameter equal to that of each wheel body.

4. The structure of multiple wheel bodies integrated with an axial base of claim 1, wherein each wheel body wears on its surface a tire made of material different from that for the wheel body.

5. The structure of multiple wheel bodies integrated with an axial base of claim 4, wherein the tire is injection molded.

6. The structure of multiple wheel bodies integrated with an axial base of claim 4, wherein the tire is casting molded.

7. The structure of multiple wheel bodies integrated with an axial base of claim 4, wherein the tire is directly mounted to the wheel body.
